(19) United States
(12) Patent Application Publication
(10) Pub. No.: US 2001/0017815 A1
(43) Pub. Date: Aug. 30, 2001

(54) Method and an assembly for the batchwise preparation of a liquid product

(76) Inventors: Fritz Ackermann, Oberwil (CH); Stephan Michels, Welsikon (CH)

Correspondence Address: Paul J. Maginot, Esq., Maginot, Addison & Moore, 111 Monument Circle, Suite 3000, Bank One Center/Tower, Indianapolis, IN, 46204-5130, US

(21) Appl. No.: 09/782,211

(22) Filed: Feb. 13, 2001

(30) Foreign Application Priority Data
Feb. 24, 2000 (CH) 361/00

(51) Int. Cl. B01F 15/02; B01F 15/04

(52) U.S. Cl. 366/152.2; 366/160.4

(57) ABSTRACT

The invention provides a method and an assembly for the batch-wise preparation of a liquid product constituted by a mixture of at least one primary liquid and at least one secondary liquid. The secondary liquid and liquids, respectfully, to be meteredly added to the flowing primary liquid are displaced, before the metered addition, from a main reservoir to a buffer reservoir. Each of the secondary liquids is conveyed by means of an associated conveyor operating according to the displacement principle. The conveyors are hydraulically operated, whereby the same liquid can be used both as hydraulic operating medium and as primary liquid. A mixing element is provided for mixing the primary liquid with the secondary liquid or liquids. The primary liquid is under pressure, since it can be blended with carbon dioxide. The secondary liquid or liquids are supplied to the mixing element under a pressure that is higher than the pressure inherent to the primary liquid in the mixing element.

### BACKGROUND OF THE INVENTION

The present invention refers, according to a first aspect, to a method for the batchwise preparation of a liquid product composed of at least one primary liquid and at least one secondary liquid. According to a second aspect, the invention also refers to an assembly for the batchwise preparation of a liquid product composed of at least one primary liquid and at least one secondary liquid.

Since such a method and such an assembly can be used, for example, in a beverage vending machine, the general problems and considerations in preparing a beverage in a beverage vending machine shall be discussed in the following. Such a method, i.e. a method within the scope of the present invention, can be applied in conventional beverage vending machines in which a cold or a warm beverage has to be prepared and dispensed into an open container, for example into a cup. As well, the method can be used for filling beverage bottles, whereby both gaseous beverages, i.e. beverages prepared on the basis of water containing carbon dioxide, as well as non-gaseous beverages can be prepared.

A fundamental disadvantage adhering to beverages prepared and dispensed by means of conventional vending machines may be seen in the fact that the used liquids and/or solid ingredients are not properly and not homogeneously, respectively, mixed in the final product, i.e. in the beverage to be dispensed. In the case of ingredients in the form of powder, the reason may be for example that the powder is not fully dissolved in the primary liquid, mostly water.

But also if the ingredients are added in liquid form, the danger exists that the final product does not exhibit a homogenous mixture of the used liquids. Different reason can be responsible therefor, one reason being that the different liquid ingredients are added to the beverage cup separately.

It is understood that a final product in which the components are not homogeneously mixed shows deficiencies as far as the expected quality of the beverage is concerned. On the one hand, the result is that the taste of the beverage is not liked by the consumer; on the other hand, an inhomogeneous beverage may be visually unpleasant.

### PRIOR ART

The document EP 0 479 113 discloses an apparatus for the preparation of beverages on the basis of at least two liquid components. For metering predetermined amounts of the components, several metering containers are provided, the outlets thereof opening via a mixing channel into a collection container. The metering container of the predominant component is designed as an overflow container. The content thereof flows, during the mixing operation, under the influence of gravity through the metering containers of the other components. The components in the smaller metering containers are metered by adjusting predetermined fill levels.

The document EP 0 443 837 discloses a method and an apparatus for metering and mixing a beverage consisting of two components. For determining the proportional mixture, the mass flow rate of the components flowing into a proportioning device is used. Thereby, the mass flow rate is measured by means of mass flow rate meters.

The document EP 0 152 283 discloses a beverage dispensing machine. To mix a first component with a second component, the beverage dispenser comprises a dual piston pump having two pistons with different dimensions that are mechanically coupled to each other. In one cylinder, a mechanically biased spring is provided that exerts a force on the one piston. The one, upper cylinder chamber can be connected to a fresh water source via an electromagnetically actuated valve. The other, lower cylinder chamber is connected via a one way check valve to a container containing a concentrate. If the upper cylinder chamber is connected to the fresh water source by actuating the electromagnetic valve, the two pistons are moved upwards, opposite to the force exerted by the spring, under the influence of the pressurized fresh water entering the upper cylinder chamber. Thereby, the lower cylinder chamber is filled with concentrate. Thereafter, when the two pistons are moved downwards under the influence of the spring, both cylinder chambers are drained. Thereby, the liquids escaping from the two cylinder chambers are mixed in a fixed relation to each other that is determined by the cross sectional area of the cylinder chambers.

The document WO 90/02702 discloses a beverage dispenser that is equipped with a dual piston pump as well, whose pistons are biased by means of a spring. The one cylinder chamber of this dual piston pump serves for receiving water, while the other cylinder chamber is provided for receiving syrup. The operation of the of the pistons is accomplished by subjecting the larger piston to a pressurized carbon dioxide gas. Thereby, both the water contained in the one cylinder chamber as well as the syrup contained in the other cylinder chamber are conveyed via pipes to a beverage container. Additionally, the conveyed water is blended with carbon dioxide in a mixing valve.

### OBJECTS OF THE INVENTION

Departing from the above discussed prior art, it is an object of the present invention to improve a method and an assembly for the batchwise preparation of a liquid product composed of at least one primary liquid and at least one secondary liquid in such a way that a high and continuous quality of the prepared final product is ensured. It is a further object of the present invention to provide a method and an assembly for the batchwise preparation of a liquid product composed of at least one primary liquid and at least one secondary liquid which offers a high degree of flexibility as far as the size and/or the composition of the batches of final product to be prepared are concerned.

### SUMMARY OF THE INVENTION

To meet these and other objects, the present invention provides, according to a first aspect, a method for the batchwise preparation of a liquid product composed of at least one primary liquid and at least one secondary liquid. In that method, first, at least one primary liquid and at least one secondary liquid are provided. Then, the primary liquid is set in flowing motion. Thereafter, a predetermined amount of the secondary liquid is individually metered. Finally, the metered amount of the secondary liquid is forcedly added to the flowing primary liquid.

Preferably, a buffer reservoir is provided for each of the secondary liquids, and the secondary liquid is displaced from the main reservoir associated with that particular secondary liquid to the buffer reservoir associated with the particular secondary liquid, before it is meteredly added to the flowing primary liquid.

According to a second aspect, the invention provided an assembly for the batchwise preparation of a liquid product composed of at least one primary liquid and at least one secondary liquid. The assembly comprises a main reservoir associated with each one of the secondary liquids, a buffer reservoir associated with each one of these main reservoirs, and conveyor devices adapted to be individually controlled to forcedly add a metered amount of the secondary liquid from its associated buffer reservoir to the flowing primary liquid.

### BRIEF DESCRIPTION OF THE DRAWINGS

In the following, preferred embodiments of the invention will be further described, with reference to the accompanying drawings, in which:

FIG. 1 shows a strictly schematic view of an assembly for the metered addition of several secondary liquids to a flowing primary liquid;

FIG. 2 shows a strictly schematic view of an alternative embodiment of an assembly for the metered addition of several secondary liquids to a flowing primary liquid;

FIGS. 3a to 3d show a first sub-assembly of the assembly of FIG. 2 for the metered addition of a first secondary liquid, in different phases of operation; and

FIGS. 4a to 4d show another sub-assembly of the assembly of FIG. 2 for the metered addition of a further secondary liquid, in different phases of operation.

### DETAILED DESCRIPTION OF THE PREFERRED EMBODIMENTS

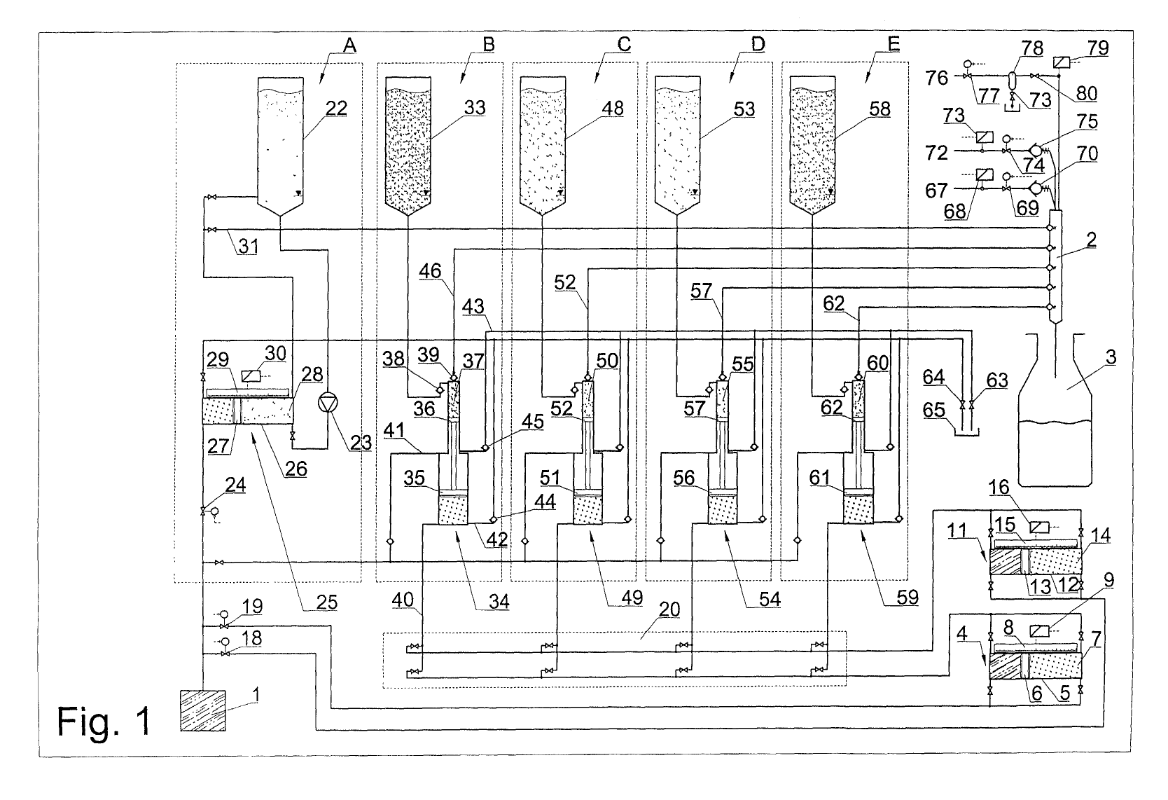

The fundamental design of a first embodiment of an assembly for the metered addition of several secondary liquids to a flowing primary liquid will be further explained, with reference to FIG. 1, in which a strictly schematic, not to scale view of the assembly is shown. The assembly shown in FIG. 1 constitutes, in the present example, a part of a beverage vending machine for dispensing a beverage to a bottle 3. By means of the method and the assembly, respectively, according to the invention, on the one hand, a user thereof should be enabled to fill bottles with varying volumes, e.g. between 0.3 and 2 liters. On the other hand, the user shall be in a position to decide about the composition of the beverage, particularly its flavor and, if appropriate, its ingredients, to a great extent. In the present example, water is used as the primary liquid, while as secondary liquids particularly sugar syrup, flavor agents, color agents as well as for example vitamins and dietary fibers are provided.

A hydraulic power supply assembly 1 is provided for generating the hydraulic control pressure required for the operation of the assembly of the invention. However, it is not mandatory that the hydraulic power supply assembly 1 be a part of the assembly of the invention, but it could be located as well outside of the assembly of the invention at any other convenient location. The assembly shown in FIG. 1 comprises two control sub-assemblies 4 and 11, a valve array 20, several system sub-assemblies A, B, C, D and E for the metered addition of different secondary liquids, supply pipes 67 and 72 for supplying the primary liquids, a supply pipe 76 for supplying a gas as well as a mixing element 2 for mixing the primary liquid or liquids, respectively, with the secondary liquids. Each system sub-assembly A, B, C, D and E is provided with a volumetric operating, hydraulically operated conveying means 25, 34, 49, 54 and 59, respectively. In the present example, as a hydraulic operating medium, water is used as well.

The control sub-assemblies 4, 11 comprise each a piston 6, 13 located in a cylinder 5, 12, whereby the pistons 6, 13 can be moved, as seen in FIG. 1, to the left side and to the right side. Both control sub-assemblies 4, 11 are hydraulically connected to the hydraulic power supply assembly and provided, for controlling the movement of the associated piston 6, 13, with a plurality of externally operated valves. The design and operation of such valves and their associated pipes being well known to any person skilled in the art removes the need to illustrate and further describe them. The two control sub-assemblies 4, 11 are hydraulically connected to the system sub-assemblies B, C, D and E via the valve array 20. By means of that valve array 20, comprising in the present example eight externally operated valves, the system subassemblies B, C, D and E can be individually hydraulically controlled, whereby the possibility is provided to simultaneously control two of the system sub-assemblies. At the outsides of each of the control sub-assemblies 4, 11, in each case a path measuring sensor 8, 15 is located. Each of the path measuring sensors 8, 15 is connected to an associated electronic detection circuitry 9, 16. The path measuring sensors 8, 15, designed for example as magnetostrictive transducers, serve for detecting the position of the pistons 6, 13. In order to influence the pressure exerted to the primary side of the pistons 6, 13 of the control sub-assemblies 4, 11, two proportional valves 18, 19 are provided. It is understood, that a control and detection circuitry (not shown) for the above mentioned components, as e.g. the valves, is provided as well. Moreover, the control and detection circuitry is also used for processing the signals supplied by the sensors, i.e. the path measuring sensors 8, 15. For the sake of clarity, that control and detection circuitry together with the associated electrical connections is not further shown in the drawings.

The first system sub-assembly A is provided with a reservoir 22 for receiving a first secondary liquid. In the present example, the first secondary liquid consists of a sugar syrup. A pump 23 is provided for conveying the first secondary liquid from the reservoir 22 to the conveying device 25. The conveying device 25 is designed as a piston or displacement conveyor and serves for the exactly metered addition of the first secondary liquid and for the forced supply of this first secondary liquid to the mixing element 2. Therefore, the piston or displacement conveyor 25 is provided with a cylinder 26 and a piston 27 located in the cylinder 26 and movable in both directions. The cylinder chamber 28 located at the right side of the piston 27 (as seen in FIG. 1) serves as a conveying buffer for receiving the secondary liquid to be meteredly added. Again, the outside of the piston or displacement conveyor 25 is provided with a path measuring sensor 29 connected to a corresponding electronic detection circuitry 30. The above described first system sub-assembly A is connected to the mixing element 2 by means of a pipe 31. If appropriate, a cooling device can be provided for keeping the secondary liquid received in the reservoir 22 cold. Moreover, means can be provided for circulating the secondary liquid received in the reservoir 22 to ensure a homogenous condition of the secondary liquid. However, these additional means are not illustrated nor will be further described, since they are well known in the art.

The second system sub-assembly B comprises a reservoir 33 filled with a second secondary liquid. In contrast to the system sub-assembly A, in the case of the sub-assembly B, no pump is provided. The reservoir 33 is provided with a reciprocating piston conveyor 34 operated by the control sub-assemblies 4, 11. The reciprocating piston conveyor 34 is provided with two pistons 35, 36 connected to each other by means of a connecting rod. In the following, the lower piston 35 (as seen in FIG. 1) will be designated as the driver piston and the upper piston 36 as metering piston. The driver piston 35 can be driven both upwards and downwards (as seen in FIG. 1) under the influence of the control sub-assemblies 4, 11, whereby the associated pipes and valves are not shown in the drawings. The metering chamber 37 located above the metering piston 36 (as seen in FIG. 1) serves as a conveying buffer by means of which the secondary liquid to be meteredly added can be volumetrically metered and forcedly supplied to the mixing element 2 via a pipe 46. The mixing element 2, subjected to the flow of the primary liquid (i.e. water, in the present example) serves for mixing the primary liquid with the secondary liquid. Thereby, the valve array 20 enables an additional driving of reciprocating piston conveyors 34, 49, 54 and 59 associated with the further system sub-assemblies B, C, D and E. Both in the pipe 46 as well as in the connecting pipe between the reservoir 33 and the reciprocating piston conveyor 34 in each case a one-way check valve 38, 39 is provided. The operation thereof is readily apparent to any person skilled in the art and has not to be further described. Moreover, the system sub-assembly B comprises two hydraulic feed pipes 40, 41 and two hydraulic outlet lines 42, 43. From the buffers 50, 55 and 60 associated with the remaining system sub-assemblies C, D and E, in each case, a pipe 52, 57 and 62 leads to the mixing element 2. These pipes 52, 57, 62, however, open into the mixing element 2 at different locations along the mixing path of the mixing element 2 through which the primary liquid is flowing.

Since the further system sub-assemblies C, D and E are of identical design as compared to the system sub-assembly B, it is not necessary to explain the design thereof in more detail.

For feeding the primary liquid in the form of water, two supply pipes 67, 72 are provided. By means of the one pipe 67, normal water is supplied, while carbonated water is supplied by means of the other pipe 72. Both pipes 67, 72 are provided with a flow rate meter 68, 73, an externally operated proportional valve 69, 74 as well as with a one-way check valve 70, 75. The two flow rate meters 68, 73 as well as the two proportional valves 69, 74 are connected to the previously mentioned, not shown electronic control circuitry. Via the pipe 76, a pressurized gas can be fed to the bottle 3 in order to pneumatically bias it, whereby a further externally operated proportional valve 77 as well as a fluid separator 78 are inserted into the pipe 76.

The mode of operation and the operational sequence of the method of the apparatus described herein before can be explained as follows:

After the operator having selected the composition of the beverage by means of an input panel and having placed the beverage bottle 3 at the location provided therefor, the bottle 3 is checked whether or not it is leaking. For this purpose, the bottle 3 is pressurized via the pipe 76 and determined if the pressure remains constant during a certain time period, e.g. a couple of seconds, or if a certain decrease in pressure over the time is not surpassed. For this leakage test as well as also for the following biasing of the beverage bottle 3, preferably a gas like nitrogen (N₂) or carbon dioxide (CO₂) is used. Moreover the size, i.e. the content of the beverage bottle 3 is determined, for example by means of a (not shown) optical sensor, or checked against a predetermined size.

It was abstained from illustrating a operator interface, e.g. a selection panel, by means of which the operator or user of the vending machine can select his beverage and determine the composition thereof. For example, it would be possible to provide a touch screen monitor by means of which the operator or user of the vending machine can select the desired beverage in a menu controlled manner. Thereby, the operator or user of the vending machine can select the size of the bottle, the kind and basis of the sweetening agent, the taste of the finished beverage as well as, within certain limits, the addition of further ingredients like dietary fibers and/or vitamins. Once the composition of the beverage has been selected, the amounts of the primary liquid and of the individual secondary liquids required for the desired total volume of the batch are calculated by means of a (not shown) calculator Thereafter, the dispensing operation is initiated and the primary liquid is fed via the pipe 67 or 72. By mixing the two primary liquids fed by the pipes 67 and 72, respectively, the content of CO₂ can be varied within wide limits. Shortly after the supply of the primary liquid(s) has been initiated, also the supply of the secondary liquid and liquids, respectively, is initiated. Thereby, the design is such that both the supply buffer for the first secondary liquid, i.e. the cylinder chamber 28 of the reciprocating piston conveyor 25, and the supply buffers for the further secondary liquids, i.e. the metering chambers 37, 50, 55, 60 of the reciprocating piston conveyors 34, 49, 54, 59, are filled with the particular secondary liquid already before the real dispensing operation starts. For meteredly adding the first secondary liquid, e.g. sugar syrup, the valve 24 is opened, with the result that the piston 27 of the reciprocating piston conveyor 25 is moved to the right side, as seen in FIG. 1. The secondary liquid contained in the cylinder chamber 28 of the reciprocating piston conveyor 25 is fed to the mixing element 2 via the pipe 31, whereby it passes a one-way check valve to get into its interior to be mixed therein with the primary liquid flowing there through.

At the same time as the first secondary liquid is meteradly added, the further secondary liquid and the further secondary liquids, respectively, are meteredly added. Depending on the design of the assembly, the secondary liquids can be fed either continuously or batch-wise. Since the movement, i.e. the stroke, of the piston 27 of the reciprocating piston conveyor 25 as well as of the pistons 6 and 13 of the two control sub-assemblies 4 and 11 are scanned by means of the associated path measuring sensors 29, 8, 15, respectively, an exactly metered addition of the particular secondary liquid can be realized since the corresponding volume can easily be calculated on the basis of the stroke of the piston and the cross sectional area of the cylinder. Such conveyor means operating according to the displacement principle and providing a volumetric metering are especially useful in the case of different secondary liquids having at least partially different viscosities. By toggling the valves associated with the particular control sub-assembly 4 and 11, respectively, both directions of movements of the pistons 6, 13 can be used for hydraulically driving the system sub-assemblies B, C, D and E.

In the present example, metering buffers 37, 50, 55 and 60 are provided that are adapted to receive only a small amount of secondary liquid, as compared to the reservoirs 33, 48, 53 and 58. Preferably, the metering buffers 37, 50, 55 and 60 are designed such that they can contain such an amount of secondary liquid that is to be added at most to the primary liquid in preparing one batch of beverage. By providing such metering buffers 37, 50, 55 and 60, the prerequisite is created that the particular secondary liquids can be metered very accurately.

By providing the afore mentioned valve array 20, two reciprocating piston conveyors can be driven by the two provided control sub-assemblies 4, 11 and, thereby, two secondary liquids can be meteredly added simultaneously. It is understood that both the number of the control sub-assemblies as well as the number of reciprocating piston conveyors can be increased, depending on the particular requirements.

In order to ensure that the water used for driving the conveyor means 25, 34, 49, 54 and 59 always meets high hygienic standards, it is renewed in regular intervals. Caused by the function of the assembly, the water is drained by means of the two valves 63, 64 located above the collection container 65. In the case of the reciprocating piston conveyors 34, 49, 54. 59, the water displaced by the piston 35 at the side remote from the pressure is drained with each movement of the piston 35, because the valves 63, 64 are open at that particular moment. Correspondingly, the operating water can be periodically replaced by opening the two valves 63, 64 when the reciprocating piston conveyors 34, 49, 54. 59 are at rest to thereby flush the associated pipes. The same is true in connection with the reciprocating piston conveyor 25. In this manner, a system is created that is sealed against the environmental atmosphere and having also sealed conveyor means, thus meeting very high hygienic standards.

Instead of the piston conveyors and reciprocating piston conveyors, respectively, as described herein before, it is understood that also diaphragm conveyors could be used. However, the advantage of the piston conveyors and reciprocating piston conveyors, respectively, as described herein before may be seen in the fact, on the one side, that the secondary liquids can be very accurately added since the amount of the conveyed secondary liquid is directly proportional to the stroke of the piston in such conveyors operating according to the displacement principle. On the other side, a comparatively high conveying pressure can be built up which is higher than the system pressure of the primary liquid flowing through the mixing element. Due to the fact that the same kind of liquid, i.e. water, is used both for the operation of the various components as well as a primary liquid, an eventually occurring “contamination” of the secondary liquid(s) by the operating liquid does not show any negative consequences.

By means of the assembly described above, it is possible to realize an accurate and reproducible metered addition of one or several secondary liquids to a primary liquid in a volume-proportional and time-proportional manner, even against an increased, not constant pressure of the primary liquid, simultaneously observing very high hygienic standards. Moreover, such an assembly is also suitable for meteredly adding for example a fiber- and/or particle-containing secondary liquid. Additionally, such an assembly can be easily bled by means of the two valves 63, 64 located above the collection container 65.

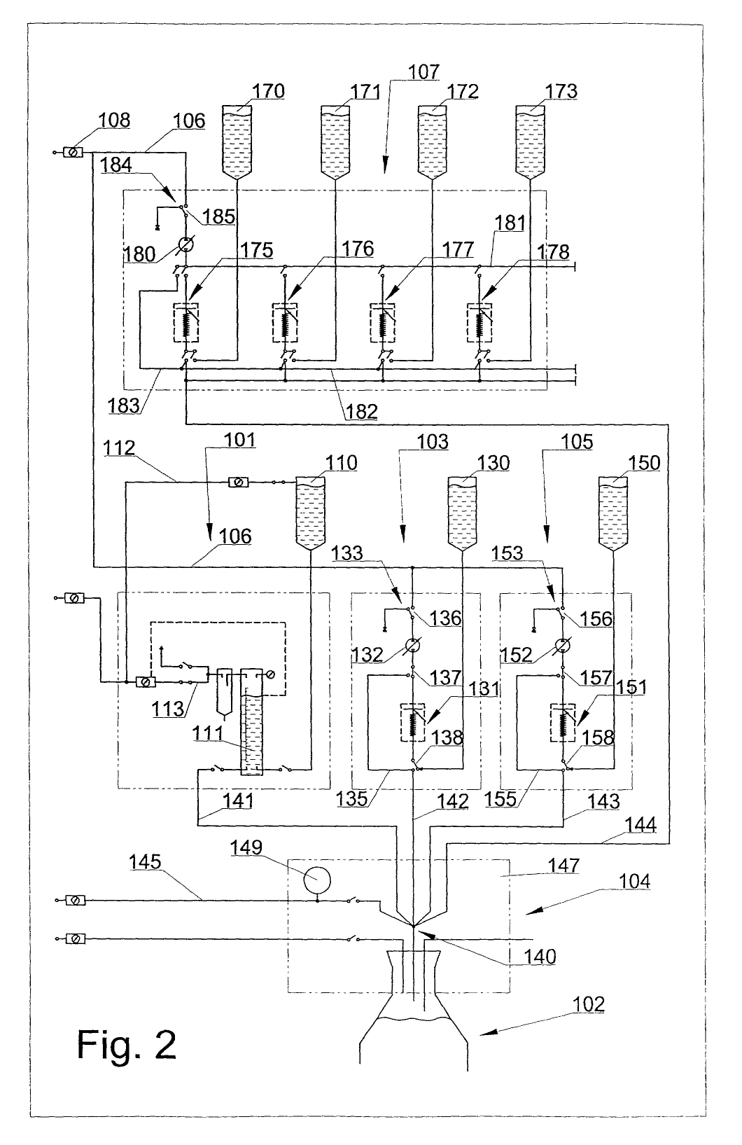

FIG. 2 shows an alternative embodiment of an assembly for the metered addition of several secondary liquids to a flowing primary liquid in a strictly schematic view. Such an assembly may be particularly useful for applications in the fields of a laboratory as well as for medical and chemical applications in which the primary liquid preferably is not under high pressure.

The assembly comprises a plurality of system sub-assemblies 101, 103, 105 and 107. Assigned to each sub-assembly 101, 103, 105 and 107 is at least one reservoir 110, 130, 150, 170, 171, 172, 173 for receiving a secondary liquid. In the present example, as viewed from the left side in FIG. 2, a reservoir 110 for receiving a first secondary liquid is assigned to the first sub-assembly, a reservoir 130 for receiving a second secondary liquid is assigned to the second sub-assembly, a reservoir 130 for receiving a third secondary liquid is assigned to the third sub-assembly, and and several reservoirs 170, 171, 172, 173 for receiving further secondary liquids are assigned to the fourth sub-assembly. Each of the reservoirs 110, 130, 150, 170, 171, 172, 173 is connected to a buffer 111, 131, 151, 175, 176, 177, 178, whereby each of these reservoirs are filled with a particular secondary liquid prior to preparing a batch. In this case, as well, the buffers 111, 131, 151, 175, 176, 177, 178 are adapted to contain a very small amount of secondary liquid, as compared to the amount of liquid contained in the reservoirs 110, 130, 150, 170, 171, 172, 173. Again, preferably that amount of secondary liquid shall be contained in the buffers 111, 131, 151, 175, 176, 177, 178 that is maximally required for preparing a batch of the mixed liquid. It is understood that the number and the placement of the reservoirs 110, 130, 150, 170, 171, 172, 173 can be varied to the same extent as the kind and amount of the secondary liquid contained therein.

Schematically shown in FIG. 2 is a container 102 adapted to receive the final mixture. Above this container 102, a filling device 104 is located. The filling device comprises a mixing 140 connected to the system sub-assemblies 101, 103, 105, 107 by means of pipes 141, 142, 143 and 144. The primary liquid can be fed via a pipe 145. In order to monitor the flow rate of the primary liquid, if appropriate, a flow rate meter 149 is provided.

The buffer of the first system sub-assembly is designed as a cylindrical container 111 whose size is chosen such that it can contain at least that amount of secondary liquid that is maximally required for preparing a batch of final liquid. For conveying the first secondary liquid, a (not shown) compressor is provided which can be connected via a pipe 112 to the reservoir 110 or via a pipe 113 to the buffer 111.

The second, third and fourth system sub-assemblies are connected to a further supply pipe for primary liquid via common pipe 106 and a regulating valve 108.

In the case of the second and the third system sub-assemblies 103 and 104, the buffers are designed as metering coils 131, 151. For conveying the corresponding secondary liquid, in each case a pump 132, 152 is located above the buffers 131, 151. Above the pumps 132, 152, in each case a drain valve 133, 153 is provided, the function of which will be explained herein after. Moreover, for bypassing the metering coils 131, 151, in each case a bypass pipe 135, 155 is provided. Each system sub-assembly 103 and 105 comprises in each case three valves 136, 137, 138; 156, 157, 158 for activating the drain valves 133, 153 of the bypass pipes 135, 155 as well as for filling and draining of the buffers 131, 151.

The fourth system sub-assembly is provided with four reservoirs 170, 171, 172, 173 for receiving secondary liquids of the same genus. Assigned to each reservoir 170, 171, 172, 173 is a buffer in the shape of a metering coil 175, 176, 177, 178. However, only one pump 180 is provided for conveying in each case one secondary liquid per batch. All inlets and outlets of the metering coils 175, 176, 177, 178 are interconnected in each case by a common pipe 181, 182. In this system sub-assembly 107 as well, a bypass pipe 183 for bypassing the metering coils 175, 176, 177, 178 is provided, as well as a drain valve 184. For filling and draining the four metering coils 175, 176, 177, 178, a plurality of valves and pipes is provided which, however, are neither shown in the drawing nor will be further explained.

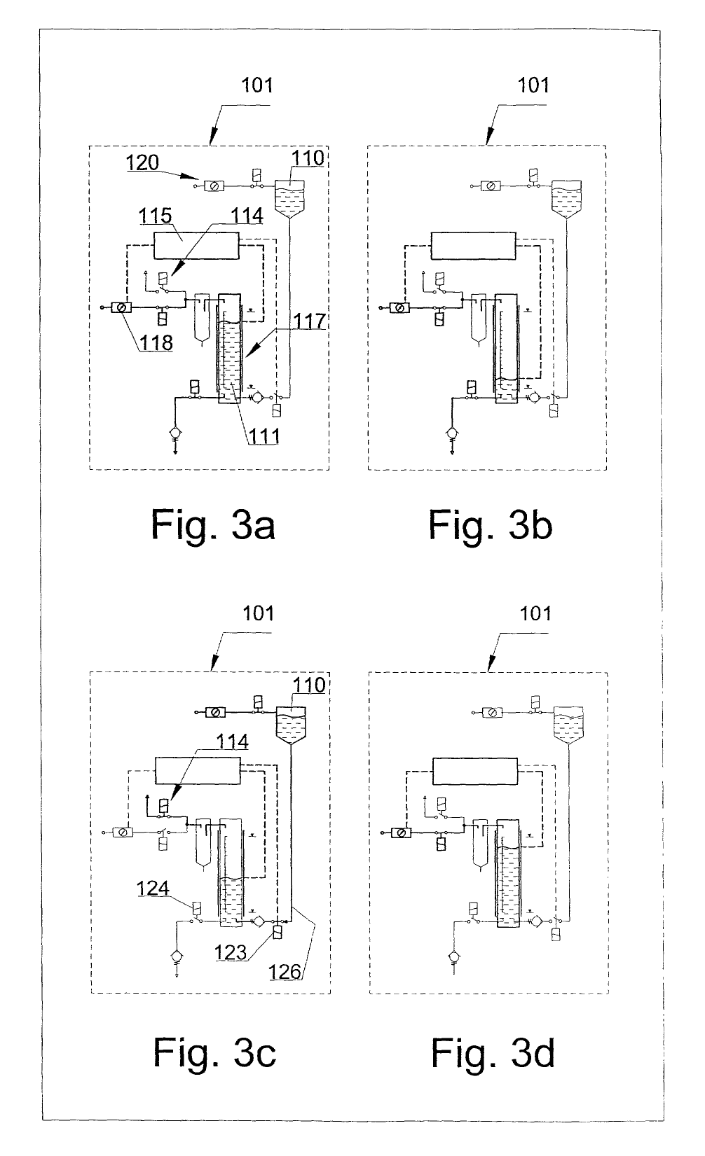

The FIGS. 3a to 3d show the first system sub-assembly 101 in different phases during the metered addition of a first secondary liquid. As can be seen from these drawing figures, that system sub-assembly comprises, besides the reservoir 110 and the buffer 110, a bleeding device 114, a regulating device 115, a level sensor 117, a first pneumatic regulating valve 118, a second pneumatic regulating valve 120 as well as various other valves.

FIG. 3a shows the system sub-assembly 101 at the beginning of the metered addition operation. The buffer 111 filled with the first secondary liquid is connected to the pressure source via the open pneumatic regulating valve 118 regulating the pressure. Thus, an overpressure is created in the buffer 111 with the result that is emptied. For regulating the overpressure in the buffer 111, the regulating device 115 is provided which is connected to the pressure regulating valve 118. At the inlet of the regulating device 115, the capacitively operating level sensor 117 is connected, by means of which the decrease of the secondary liquid contained in the buffer per time unit is detected and kept at a predetermined value by means of the regulating device 115. The decrease of the secondary liquid in the buffer 111 per time unit directly corresponds to the amount of secondary liquid meteredly added per time unit to the primary liquid.

As is also the case in connection with the remaining secondary liquids, the amount of secondary liquid meteredly to be added to the primary liquid depends on several parameters. On the one side, the flow rate of the primary liquid has to be considered. On the other side, it depends on the desired amount ratio between primary and secondary liquid.

FIG. 3b shows the state of the system sub-assembly 101 towards the end of the operation of metered adding secondary liquid.

In FIG. 3c, the system sub-assembly 101 is shown in a snapshot during the refill of the buffer 111. For this purpose, the valve 123 at the outlet of the buffer 111 has been switched to its open position, while the inlet valve 124 is switched to its locked position, consequently, the buffer 111 is connected to the reservoir 110 via the pipe 126 and can be refilled therefrom with secondary liquid. Thereby, the reservoir 110 is subjected to an overpressure with the result that the secondary liquid is forced to flow into the buffer 111. The air displaced by the secondary liquid flowing into the buffer 111 can escape from the buffer 111 through the bleeding device 114.

In FIG. 3d, the system sub-assembly 101 is shown in its initial state, in which the buffer 111 is filled and ready for preparing a next batch of the final liquid product.

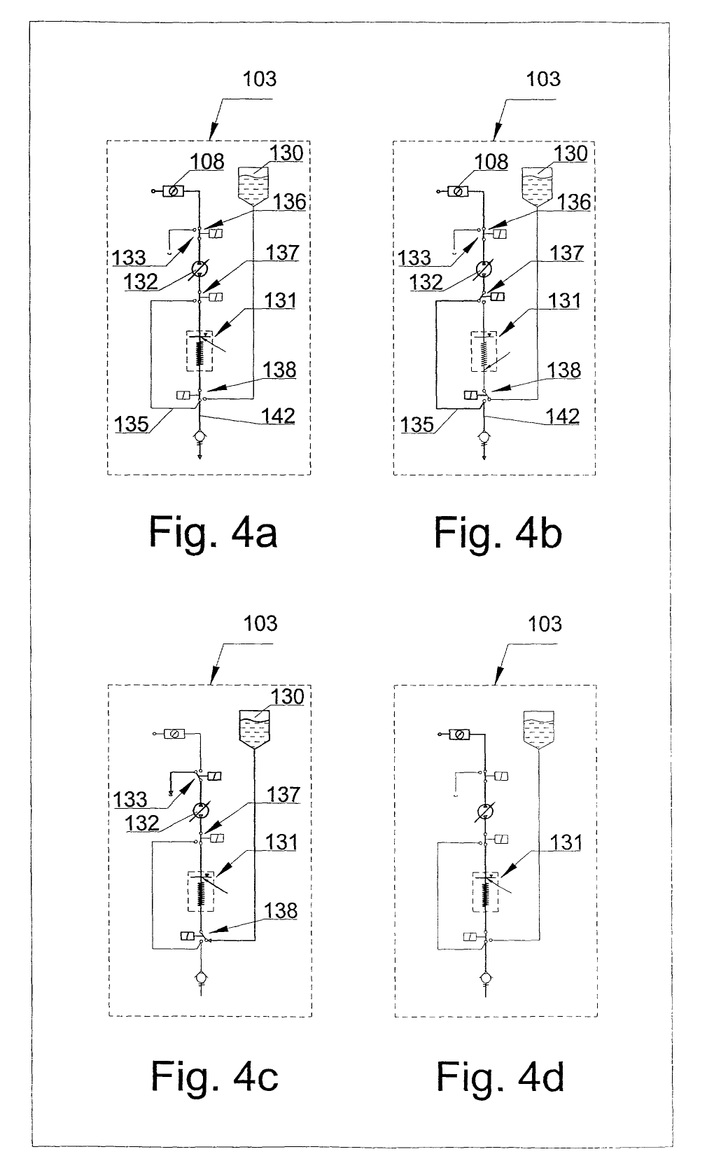

The FIGS. 4a to 4d show the second system sub-assembly 103 in differences phases while a second secondary liquid is meteredly added to the primary liquid. The pump 132 is connected to the primary liquid source via the regulating valve 108. Particular attention earns the fact that the pump 132 is not subjected to the secondary liquid, i.e. the secondary liquid does not flow through the pump 132, but that a overpressure or a subatmospheric pressure is transferred to the secondary liquid by a intermediate agent, i.e. water in the present example, to provide a refill or a drain of the buffer 131. In order to avoid a mixing of the intermediate agent—water—and the secondary liquid received in the metering coil, the two media, i.e. water and secondary liquid, can be separated by means of e.g. an air bubble. However, the means for generating such an air bubble are not shown.

Once the desired amount of secondary liquid has been meteredly added to the primary liquid, the pipe 142 running from metering coil 131 to the mixing valve 140 (FIG. 1) can be flushed by means of primary liquid, i.e. in the present example water. For this purpose, the two valves 137, 138 are toggled, as shown in FIG. 4b, and the water, up to now serving as an intermediate agent, is bypassed through the bypass pipe 135 around the metering coil 131. Thereby, the pipe 142 running from the metering coil 131 to the mixing valve 140 is flushed with water and residues of the secondary liquid are removed. Such flushing is particularly important if different secondary liquids can be added via the pipe 142 running from the metering coil 131 to the mixing valve 140, as is the case for example in the fourth system sub-assembly 107 (cf. FIG. 2). This operating of flushing is controlled such that all residues of secondary liquid used for the particular batch are completely removed from the pipe 142, but attention is paid to the fact that finally only a very small amount of flushing liquid gets into the container 102.

FIG. 4c shows the system sub-assembly 103 during the refilling of the metering coil 131. Thereby, the two valves 137, 138 are toggles again and the drain valve 133 is opened. Now, a subatmospheric pressure is generated by means of the pump 132, with the result that the secondary liquid is sucked from the reservoir 130 into the metering coil 131. For instance a suitable optical sensor can be used to indicate when the metering coil 131 is filled to its top. Via the opened drain valve 133, both pipe sections can be bled and liquid residues can be drained.

In FIG. 4d, the system sub-assembly 103 is shown in its initial state, in which the metering coil 131 is refilled with the secondary liquid again.

By using the assembly described herein before, a maximum of flexibility with regard to possible composition of the final liquid product can be achieved. While the assembly described as a first embodiment is particularly suitable for meteredly adding a secondary liquid to a pressurized primary liquid, the assembly according to the second embodiment constitutes an alternative that is simpler in design and cheaper, but is particularly suitable for meteredly adding a secondary liquid to primary liquid that is not pressurized or is just under a slight overpressure. The assembly according to the second embodiment is also particularly suitable for meteredly adding but very small amounts of secondary liquids.

What is claimed is:

1. A method for the batch-wise preparation of a liquid product composed of at least one primary liquid and at least one secondary liquid, comprising the steps of:
providing at least one primary liquid;
providing at least one secondary liquid;
setting said at least one primary liquid in flowing motion;
individually metering a predetermined amount of said at least one secondary liquid; and
forcedly adding said metered amount of said at least one secondary liquid to said at least one flowing primary liquid.

2. A method according to claim 1, further comprising the steps of:
providing a main reservoir means for each of said at least one secondary liquids;
providing a buffer reservoir means for each of said at least one secondary liquids;
displacing said at least one secondary liquid from said main reservoir means associated with said particular at least one secondary liquid to said buffer reservoir means associated with said particular at least one secondary liquid; and
meteredly adding said at least one secondary liquid to said at least one flowing primary liquid.

3. A method according to claim 1 or 2, further comprising the steps of:
providing a plurality of secondary liquids;
providing a mixing element means adapted to be passed by said at least one flowing primary liquid, said mixing element means comprising a plurality of inlet means for said plurality of secondary liquids; and
feeding each particular secondary liquid of said plurality of secondary liquids to a different inlet means of said plurality of inlet means to add each particular secondary liquid of said plurality of secondary liquids at a different location to said at least one primary liquid flowing through said mixing element means.

4. A method according to claim 1 in which each of said at least one secondary liquids is volumetrically metered and added to said at least one flowing primary liquid under overpressure.

5. A method according to claim 4 in which each of said at least one secondary liquids is added to said at least one flowing primary liquid by means of an associated conveyor means operating according to the displacement principle.

6. A method according to claim 5 in which said conveyor means is/are hydraulically operated by means of a liquid operating means.

7. A method according to claim 3 in which said at least one primary liquid is passed through said mixing element means with a first pressure, whereby each particular secondary liquid of said plurality of secondary liquids is fed to a different inlet means of said plurality of inlet means of said mixing element means with a second pressure which is higher than said first pressure.

8. A method according to claims 1 and 5, further comprising the steps of:
providing a main reservoir means for each of said at least one secondary liquids;
providing a conveyor means having a cylinder chamber means serving as a buffer reservoir means for each of said at least one secondary liquids;
displacing said at least one secondary liquid from said main reservoir means associated with said particular at least one secondary liquid to said cylinder chamber means of said conveyor means associated with said particular at least one secondary liquid; and
meteredly adding said at least one secondary liquid to said at least one flowing primary liquid; whereby
said conveyor means is provided with a hydraulically movable metering piston means.

9. A method according to claims 1 and 6 in which said at least one primary liquid and said liquid operating means are constituted by the same medium.

10. A method according to claims 1 and 6 in which said at least one primary liquid and said liquid operating means are constituted predominantly by water.

11. A method according to claim 1 in which said step of forcedly adding said metered amount of said at least one secondary liquid to said at least one flowing primary liquid is performed continuously or in intervals.

12. A method according to claim 1 in which the magnitude of said metered predetermined amount of said at least one secondary liquid to be forcedly added to said at least one flowing primary liquid per time unit is adjusted in dependence on the flow rate of said at least one flowing primary liquid and/or on the absolute amount of said at least one flowing primary liquid required per batch as well as on the desired volume ratio between said at least one primary liquid and said at least one secondary liquid.

13. A method according to claim 12 in which said flow rate of said at least one flowing primary liquid is measured and/or arithmetically calculated.

14. A method according to claim 1 in which said step of forcedly adding said metered amount of said at least one secondary liquid to said at least one flowing primary liquid is performed in intervals, whereby the number and/or the length of said intervals is adjusted in dependence on the flow rate of said at least one flowing primary liquid and/or on the absolute amount of said at least one flowing primary liquid required per batch as well as on the desired volume ratio between said at least one primary liquid and said at least one secondary liquid.

15. A method according to claim 1 in which said step of forcedly adding said metered amount of said at least one secondary liquid to said at least one flowing primary liquid is terminated prior to having reached the amount of said at least one primary liquid required for preparing a particular batch.

16. A method according to claim 1 in which two primary liquids are provided, whereby one of said two primary liquids is blended with carbon dioxide and whereby said two primary liquids can be mixed in any desired ratios to adjust the content of carbon dioxide.

17. A method according to claim 2 in which said step of displacing said at least one secondary liquid from said main reservoir means associated with said particular at least one secondary liquid to said buffer reservoir means associated with said particular at least one secondary liquid is performed by means of a pump means, whereby an intermediary medium is provided that flows through said pump means and by means of which an overpressure or a subatmospheric pressure created by said pump means can be transferred to said at least one secondary liquid for filling or draining said buffer reservoir means.

18. A method according to claim 17 in which said buffer reservoir means is drained by a suction operation and filled by means of an overpressure.

19. A method according claims 17 or 18 in which the supply of said at least one secondary liquid to said buffer reservoir means is stopped before the amount of primary liquid required for preparing a batch of final product is reached, whereby pipes through which secondary liquids can be supplied that may differ from batch to batch are flushed by means of said at least one primary liquid after said supply of said at least one secondary liquid to said buffer reservoir means is stopped.

20. A method according to claims 17 or 18 in which pipes through which secondary liquids can be supplied that may differ from batch to batch are flushed by means of said intermediary medium at the end of said step of forcedly adding said metered amount of said at least one secondary liquid to said at least one flowing primary liquid.

21. A method according to claim 17 in which a gaseous, liquid or solid separating means is inserted between said at least one secondary liquid to be displaced from said main reservoir means to said buffer reservoir means by means of said pump means and said intermediary medium flowing through said pump means.

22. A method according to claim 1, further comprising the steps of:
providing a hydraulically operated control sub-assembly means including a cylinder means and a piston means having an operating stroke and operated by a hydraulic medium; and
providing a path measuring sensor means adapted to detect the length of said operating stroke of said piston means; whereby
said step of forcedly adding said metered amount of said at least one secondary liquid to said at least one flowing primary liquid is performed by operating said piston means, the magnitude of said metered amount of said at least one secondary liquid to be forcedly added to said at least one flowing primary liquid per time unit being determined by the path length per time unit of said operating stroke of said piston means measured by means of said path measuring sensor means.

23. An assembly for the batch-wise preparation of a liquid product composed of at least one primary liquid and at least one secondary liquid, comprising:
a main reservoir means associated with each one of said at least one secondary liquid;
a buffer reservoir means associated with each one of said main reservoir means;
conveyor means adapted to be individually controlled to forcedly add a metered amount of said at least one secondary liquid from its associated buffer reservoir means to said at least one flowing primary liquid.

24. An assembly according to claim 23 in which a separate conveyor means is provided for each secondary liquid to be added to said flowing primary liquid, said conveyor means operating according to the displacement principle and its conveying rate being adjustable.

25. An assembly according to claims 23 and 24 in which said buffer reservoir means is an integrated part of said conveyor means.

26. An assembly according to claim 1, further comprising:
a mixing element means having inlet opening means and adapted to mix said at least one primary liquid and said at least one secondary liquid; and
pipe means adapted to connect each of said buffer reservoir means with said mixing element means.

27. An assembly according to claim 26 in which each of said pipe means is provided with a check valve means located in the region of said inlet opening means of said mixing element means and adapted to prevent a penetration of liquid from said mixing element means into said pipe means.

28. An assembly according to claim 26 in which a plurality of pipe means is provided, said mixing element means through which said primary liquid flows having a plurality of inlet opening means located at different locations along the mixing path of said mixing element means, each of said pipe means of said plurality of pipe means being connected with one of said inlet means.

29. An assembly according to claim 24 in which said conveyor means is hydraulically operated.

30. An assembly according to claim 29 in which the same medium is used both for operating said hydraulically operated conveyor means and as said at least one primary liquid.

31. An assembly according to claim 30 in which said medium used both for operating said hydraulically operated conveyor means and as said at least one primary liquid is predominantly water.

32. An assembly according to claim 29 in which each of said hydraulically operated conveyor means comprises a hydraulically operated piston means adapted to directly or indirectly convey a secondary liquid.

33. An assembly according to claim 24 in which said conveyor means comprises a first piston means and a second piston means, said first and second piston means being interconnected with a piston rod means, said first piston means being designed as operating piston, both opposite surfaces thereof being subjectable to a hydraulic operating medium such as to be movable in different directions, and said second piston means being designed as metering piston for conveying the particular secondary liquid.

34. An assembly according to claim 33 in which the surface area of said first operating piston means is a multiple of the surface area of said second metering piston.

35. An assembly according to claim 23, said conveyor means further comprise hydraulically operated piston means for adding said at least one secondary liquid to said flowing at least one primary liquid, said hydraulically operated piston means being provided with a path sensor means adapted to measure the stroke of said hydraulically operated piston means, whereby the magnitude of the measured stroke is used as a measure for the magnitude of the conveyed volume of secondary liquid.

36. An assembly according to claims 33 or 34, further comprising at least one hydraulic control means for operating said operating piston means of said conveyor means, said hydraulic control means comprising a control piston means provided with a path sensor means, whereby the magnitude of the measured stroke is used as a measure for the magnitude of the conveyed volume of secondary liquid.

37. An assembly according to claim 23, comprising at least one conveyor means adapted to fill at least one buffer reservoir means with secondary liquid and/or to drain the secondary liquid from at least one buffer reservoir means, said at least one conveyor means being adapted to be controllable such that the amount of secondary liquid to be meteredly added to the primary liquid per time unit is variable.

38. An assembly according to claim 37, further comprising an intermediary medium means by means of which an overpressure or a subatmospheric pressure created by said at least one conveyor means can be transferred to the secondary liquid for the purpose of filling and/or draining of said buffer reservoir means such that said secondary liquid conveyed from said buffer conveyor means does not flow through said at least one conveyor means.

39. An assembly according to claim 38 in which a fluid or gaseous intermediary medium means is provided, and in which said at least one conveyor means is designed as a pump means or as a compressor means.

40. An assembly according to claim 37 in which said buffer reservoir means can be filled under the influence of the suction effect of said at least one conveyor means and can be drained under the influence of the pressure effect of said at least one conveyor means.

41. An assembly according to claim 37, comprising at least one buffer reservoir means designed as a metering cylinder or as a metering coil.

42. An assembly according to claim 37 in which several buffer reservoir means are provided adapted to receive different secondary liquids and that are combined in groups, whereby means are provided for selectively designating and meteredly adding the secondary liquids combined in one of said groups, whereby the particular group is provided with a common collection pipe means for feeding the selected secondary liquid.

43. An assembly according to claim 42 in which there is provided a bypass pipe means by means of which said intermediary medium means conveyed by said conveyor means can be bypassed around said buffer reservoir means into said common collection pipe means, such that said collection pipe means can be flushed by means of said intermediary medium means.

44. An assembly according to claim 42 or 43 in which secondary liquids of the same general kind are combined in groups, whereby a conveyor means is associated with each of said groups.

45. An assembly according to claim 38 in which there is provided a gas bubble means for separating said intermediary medium means from said secondary liquid.

46. Application of the method according to one or several of the claims 1-22 for the preparation of beverages, particularly for preparing gaseous cold beverages.

47. Application of the method according to one or several of the claims 1-22 for the preparation of liquid pharmaceutical, chemical or cosmetic preparations.

48. Use of the assembly according to one or several of the claims 23-45 in a beverage vending machine for the preparation of beverages, particularly of gaseous cold beverages.

49. Use of the assembly according to one or several of the claims 23-45 in a vending machine for the preparation of liquid pharmaceutical, chemical or cosmetic preparations.
